(19) United States
(12) Patent Application Publication
(10) Pub. No.: US 2005/0189336 A1
(43) Pub. Date: Sep. 1, 2005

(54) Electrode holder

(76) Inventor: Ju-Ching Ku, Kaohsiung Hsien (TW)

Correspondence Address: Leong C. LEI, PMB#1008, 1867 Ygnacio Valley Rd.,, Walnut Creek, CA, 94598-3214, US

(21) Appl. No.: 11/062,925

(22) Filed: Feb. 23, 2005

(30) Foreign Application Priority Data
Mar. 1, 2004 (TW) 093203025

(51) Int. Cl. B23K 9/00

(52) U.S. Cl. 219/138

(57) ABSTRACT

An electrode holder comprised of a press and a clamp has at the bottom of the clamp adapted with a cylindrical base to allow one end of an electrode lead to pass through; the lead end being fastened in place by a bolt in conjunction with a protection pad covering up the cylindrical base so that in the course of welding, the point of heat conduction being kept farthest as from the hand gripping the holder to achieve working comfort.

### BACKGROUND OF THE INVENTION

(a) Technical Field of the Invention

The present invention is related to an electrode holder, and more particularly to one that improves work comforts by keeping the hand gripping the holder away from being affected by heat conduction.

(b) Description of the Prior Art

Economic growth drives the advancement made in industrial technology. In earlier time, the binding between two objects relied upon adhesion or tying. However, either way provides limited binding force as required and is applicable to the binding between two metal objects. Later, bolting and welding process was introduced. For the welding process, a welding machine and an electrode holder are used. Wherein, the electrode holder is connected to the welding machine by means of an electrode lead. A ground cable from the welding machine is connected to the work piece to be welded to become a loop while the electrode holder clamps an electrode rod. The electrode rod relates to a metal rod cover up with solder. In the welding process, the electrode rod clamped by the electrode holder contacts the point where the welding is desired, and the electrode rod is conducted to create arc. Heat at high temperature generated by the arc infuses the point for incorporating both objects into one for achieving better fixation result. As illustrated in FIGS. 1 and 2 of the accompanying drawings, an electrode holder of the prior art is essentially comprised of a clamp 1 and a press 2 adapted to the clamp by means of a locking pin. The clamp 1 related to a stick generally made of copper or any other conductive material is comprised of a clamping section 11 and a cylinder 2. The front of the clamping section 11 has an irregularly shaped upper edge and protected by a plastic bracket 12 fastened with two screws to the bottom of the clamping section 11 to prevent electric shock. A cylinder 13 is disposed at the rear end of the clamping section 11 to receive the insertion of an end 31 from an electrode lead 3. The end 31 of the electrode lead 3 is then secured in place by means of multiple screws 14 disposed at the bottom of the cylinder 13. The cylinder 13 is then inserted into a bakelite lever 15 and secured in place by means of a fastener 16 to prevent the grip 15 from falling of the cylinder 13. The front of the press 2 is made a flushed straight compression section 21 and the rear a curved pressing lever 22 clad with a sheath made of bakelite. A pin 23 is used to connect the clamp 1 and where the compression section contacts the pressing lever 22. The pressing lever 22 holds against where behind the clamping section 11 of the clamp 1 by means of a coil 24. When the pressing lever 22 is pressed, the compression section 21 in the front of the press 2 and the clamping section 11 to open up or close up with the pin 23 as a support by taking advantage of the return force of the coil 24. An insulation cover 25 protects the upper part of the compression section 21 and the cover 25 is secured to the compression section with a screw 26. However, one end 31 of the lead 3 entering into the cylinder 13 is secured in the cylinder 13 in the rear end of the clamp 1 and even with the presence of the insulation grip 15 covering up the cylinder 13 to prevent electric shock, the point where the lead end 31 contacts the cylinder 13 also generates heat due to conduction. Such heat could become unbearable to the worker even wearing gloves and the work has to take a rest to wait for the temperature to cool down, thus suspended welding job and extended work hours.

### SUMMARY OF THE INVENTION

The primary purpose of the present invention is to provide an electrode holder that has at the bottom of a clamp of the handle provided with a fixation base to allow one end of an electrode lead to pass through; and the lead is fastened in place by a bolt in conjunction with a protection pad so that in the course of welding, the point of high temperature created by heat conduction is kept farthest from the hand gripping the holder to achieve working comfort.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an electrode holder of the prior art.

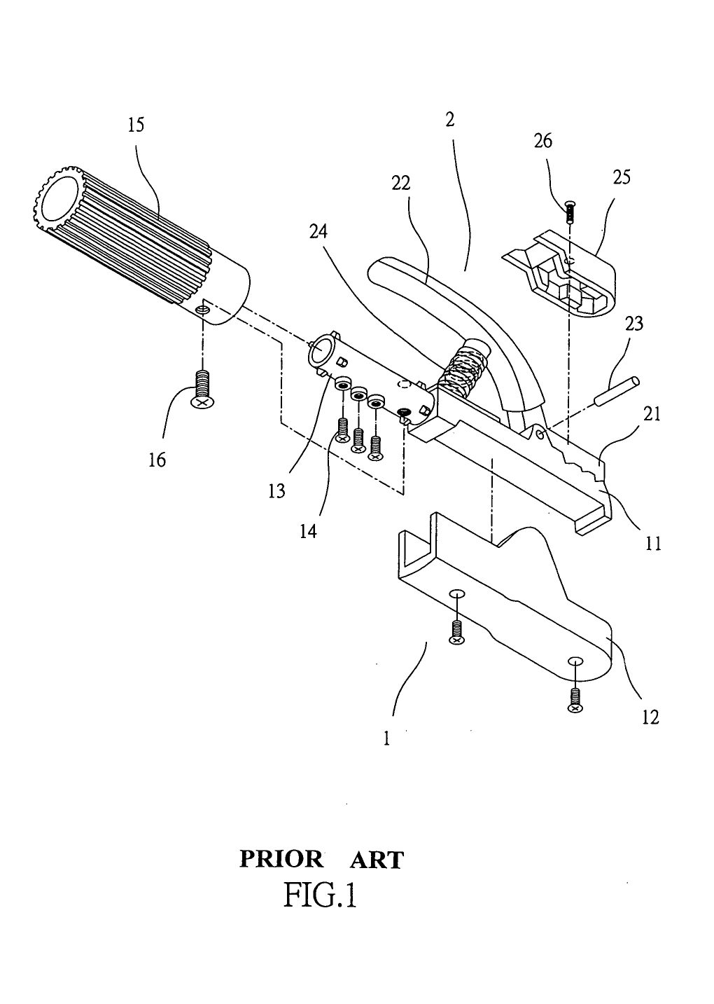

FIG. 2 is a sectional view of the prior art.

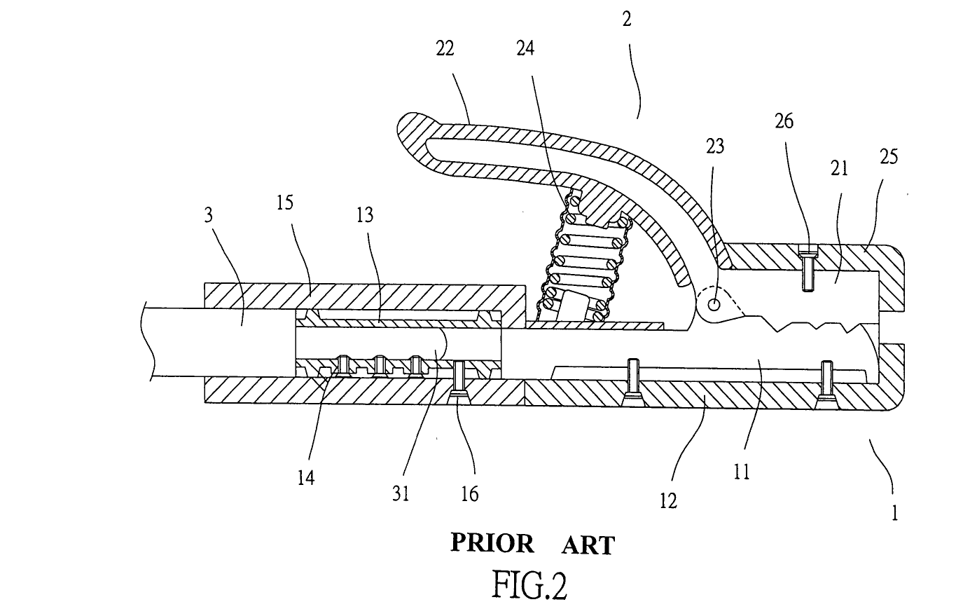

FIG. 3 is an exploded view of a preferred embodiment of the present invention.

FIG. 4 is a sectional view of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

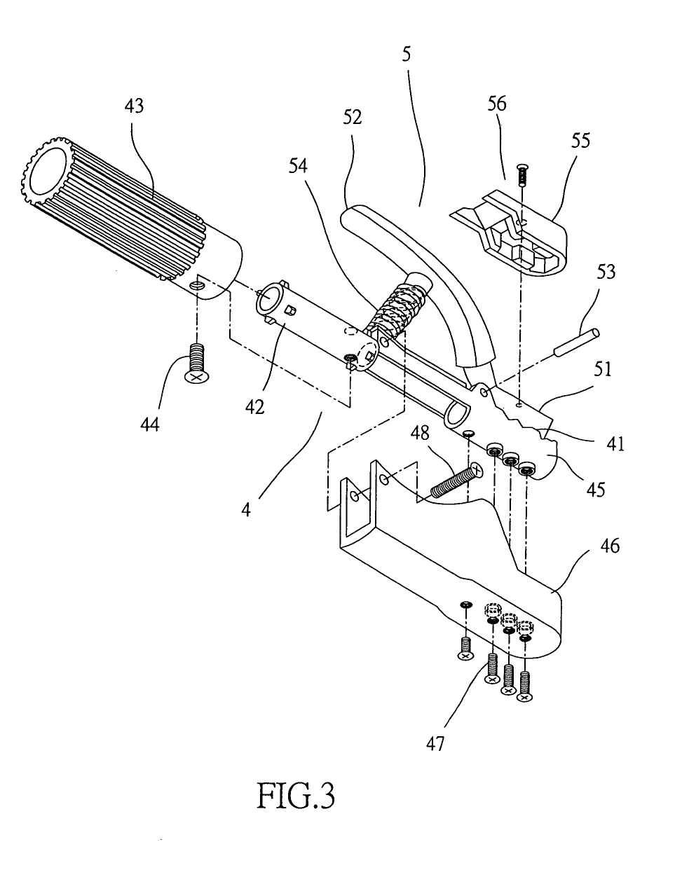

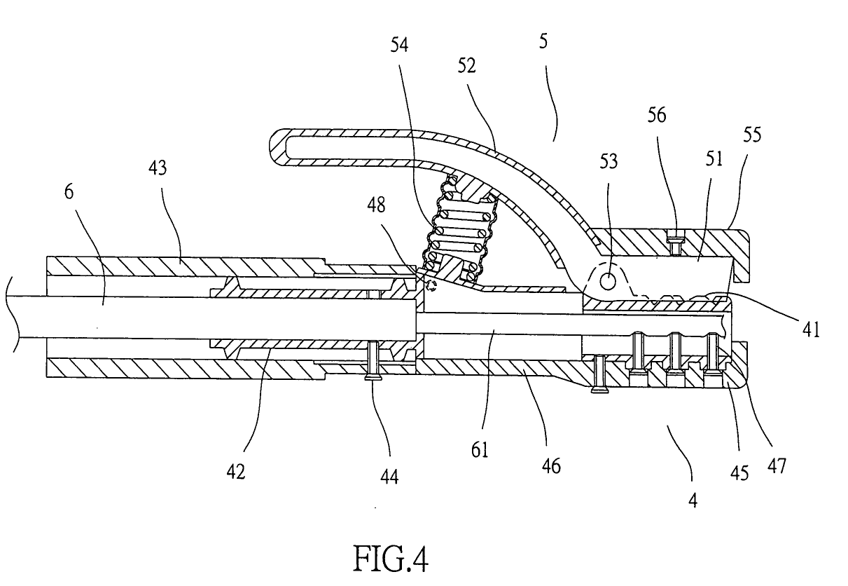

Referring to FIGS. 3 and 4, a preferred embodiment of the present invention related to an electrode holder is essentially comprised of a clamp 4 and a press 5. The clamp 4 includes a clamping section 41 at its front and a cylinder 42 at its rear. The clamping section 41 has an irregularly shaped upper edge. An electrode lead 6 penetrates through the cylinder 42 and the cylinder 42 is insulated with a grip 43. The proximate end of the grip 43 to the clamping section 41 is secured to the cylinder 42 by means of a screw 44. The press 5 has a flushed straight compressing section 51 in the front and a curved lever 52 extending from the rear. A locking pin 53 is used to lock the press 5 to the clamp 4. The curved lever 52 is inserted into an insulation sheath. A coil 54 is adapted to the lever 52 for the lever 52 to hold against the rear of the clamping section 41 for the compression section 51 of the press 5 to swing using the pin 53 as a support. An insulation cover 55 secured to the compression section by means of a screw 56 protects the compression section 51. The present invention is characterized by that a cylindrical base 45 provided below the clamping section 41. The cylindrical base 45 is made integrated with the clamping section 41 and connected through the cylinder 42. Accordingly, when the electrode lead 6 passes through the cylinder 42, its end 61 is secured in the lower portion of the cylindrical base 45. A protection pad 46 covers up and is secured to the cylindrical base 45 by means of multiple screws 47 to prevent exposure of the cylindrical base and thus electric shock.

Whereas the cylindrical base 45 fastened to the bottom of the clamping section 41 to allow penetration and secure in place the end 61 of the electrode lead 6, the hand of the worker holding the grip 43 will not be affected by the heat generated from the end 61 of the electrode lead 6 to achieve the purposes of consistent welding job without extended work hours.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An electrode holder is comprised of a clamp and a press; the clamp including a clamping section and a cylinder; the front of the clamping section having an irregularly shaped upper edge; an insulation pad being secured below the clamping section by means of a fastener; the rear end of the clamp being related to a cylindrical insertion section to receive insertion of an electrode lead; the cylinder being wrapped up with a protection grip made of insulation material; the front side of the press being related to a flushed straight compression section; a curved lever extending from the rear side of the press and being connected to the clamp with a pin; the lever being wrapped up with an insulation material; a coil from the compression section holding against the rear of the lever; the upper part of the compression section is protected by an insulation cover; a cylindrical base being defined between the clamping section and the protection pad; the cylindrical base being connected through the cylinder; and the end of the lead passing through the cylinder being secured in place in the cylindrical base.
